(19) United States
(12) Patent Application Publication
(10) Pub. No.: US 2014/0278675 A1
(43) Pub. Date: Sep. 18, 2014

(54) NEGOTIATED MEETING SCHEDULING WITH ONE OR MORE REQUIRED ATTENDEES

(71) Applicant: INTERNATIONAL BUSINESS MACHINES CORPORATION, Armonk, NY (US)

(72) Inventors: Lisa Seacat DeLuca, Baltimore, MD (US); Dana L. Price, Cary, NC (US); Nagarjuna R. Vemireddy, Charlotte, NC (US)

(73) Assignee: INTERNATIONAL BUSINESS MACHINES CORPORATION, Armonk, NY (US)

(21) Appl. No.: 13/838,651

(22) Filed: Mar. 15, 2013

(51) Int. Cl. G06Q 10/10

(52) U.S. Cl. CPC G06Q 10/1095
USPC 705/7.19

(57) ABSTRACT

Various embodiments provide for negotiated scheduling of a meeting with one or more required meeting attendees before sending out invitations(s) to one or more optional meeting attendees. In one specific example, mechanisms are provided for iterative scheduling which includes proposed times and counter proposals to/from the required meeting attendee(s). In another specific example, mechanisms are provided for sending a meeting invitation to each optional meeting attendee once an agreement is reached among required meeting attendee(s) regarding the time of the meeting.

### BACKGROUND

The present disclosure relates generally to negotiated meeting scheduling with one or more required attendees.

### DESCRIPTION OF RELATED ART

When scheduling a meeting with multiple attendees, some attendees being required (often listed in the To: portion of a communication) and some attendees being optional (often listed in the cc: of a communication), it is typically difficult to find the “right” time. The required people typically have precedence in the initial scheduling, but the conventional automated systems of choosing an available time are not always fail-safe. Often, some of the required attendees will accept, but one or more may not be available, and the time selection typically has to begin all over again. In the meantime, the optional attendees have typically already blocked-out their schedules according to the original proposed time.

Conventionally, one way this is handled is for the meeting organizer to keep rescheduling manually, and for the optional attendees to get meeting update after meeting update, until the required attendees have all responded positively (that is, agreed to the meeting time). Another solution is for the meeting organizer to send a separate communication outside the normal communication channel to the required attendees, asking for confirmation of acceptance of a proposed time before sending an invitation to the required and optional attendees.

Yet another conventional solution is manually sending a meeting request to a required set of people, negotiating a time and then manually adding the optional participants to the meeting after it is set. For example, when there are large sets of people to invite, all important people may be invited then optional people added later. However, the scheduling person has to remember all of this and be involved manually a second time to add in those optional people. That is, this conventional manual process required the moderator to constantly be aware of the scheduling and remember to come back and modify the attendance list after the meeting had been set.

### SUMMARY

In one example, negotiated meeting scheduling is carried out for at least two required attendees and at least one optional attendee.

In other examples, negotiated meeting scheduling with at least two required attendees and at least one optional attendee may be implemented in the form of systems, methods and/or algorithms.

In other examples, methodologies may be provided that automatically negotiate meeting scheduling between/among required attendees.

In one embodiment, a computer-implemented method for scheduling a meeting with at least one required meeting attendee and at least one optional meeting attendee is provided, the method comprising: receiving, by a processor, an identification of a first set of meeting attendees, wherein the first set of meeting attendees comprises at least one required meeting attendee; receiving, by the processor, an identification of a second set of meeting attendees, wherein the second set of meeting attendees comprises at least one optional meeting attendee; sending by the processor, after receipt of the identification of the first and second sets of meeting attendees, a required meeting attendee invitation to each required meeting attendee but not to any optional meeting attendee, wherein each required meeting attendee invitation comprises a proposed time for the meeting; receiving, by the processor, from each required meeting attendee a response to the respective required meeting attendee invitation; determining by the processor, based upon the response received from each respective required meeting attendee, whether each required meeting attendee has accepted the respective required meeting attendee invitation; and sending by the processor, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In another embodiment, a computer readable storage medium, tangibly embodying a program of instructions executable by the computer for scheduling a meeting with at least one required meeting attendee and at least one optional meeting attendee is provided, the program of instructions, in executing, performing the following steps: receiving an identification of a first set of meeting attendees, wherein the first set of meeting attendees comprises at least one required meeting attendee; receiving an identification of a second set of meeting attendees, wherein the second set of meeting attendees comprises at least one optional meeting attendee; sending, after receipt of the identification of the first and second sets of meeting attendees, a required meeting attendee invitation to each required meeting attendee but not to any optional meeting attendee, wherein each required meeting attendee invitation comprises a proposed time for the meeting; receiving from each required meeting attendee a response to the respective required meeting attendee invitation; determining, based upon the response received from each respective required meeting attendee, whether each required meeting attendee has accepted the respective required meeting attendee invitation; and sending, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In another embodiment, a computer-implemented system for scheduling a meeting with at least one required meeting attendee and at least one optional meeting attendee is provided, the system comprising: an input element configured to receive: (a) an identification of a first set of meeting attendees, wherein the first set of meeting attendees comprises at least one required meeting attendee, and (b) an identification of a second set of meeting attendees, wherein the second set of meeting attendees comprises at least one optional meeting attendee; a required meeting attendee invitation sending element configured to send, after receipt of the identification of the first and second sets of meeting attendees, a required meeting attendee invitation to each required meeting attendee but not to any optional meeting attendee, wherein each required meeting attendee invitation comprises a proposed time for the meeting; a receiving element configured to receive from each required meeting attendee a response to the respective required meeting attendee invitation; a determining element configured to determine, based upon the response received from each respective required meeting attendee, whether each required meeting attendee has accepted the respective required meeting attendee invitation; and an optional meeting attendee invitation sending element configured to send, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

### BRIEF DESCRIPTION OF THE DRAWINGS

Various objects, features and advantages of the present invention will become apparent to one skilled in the art, in view of the following detailed description taken in combination with the attached drawings, in which:

FIGS. 1A and 1B depict a flowchart of an example implementation according to one embodiment.

FIGS. 2A and 2B depict a flowchart of an example implementation according to another embodiment.

FIG. 3 depicts a block diagram of a system according to one embodiment.

FIG. 4 depicts a block diagram of a system according to another embodiment.

FIG. 5 depicts a block diagram of a system according to another embodiment.

### DETAILED DESCRIPTION

In one example, one or more systems may provide for negotiated meeting scheduling with required attendees (e.g., automated negotiated meeting scheduling with required attendees). In another example, one or more methods may provide for negotiated meeting scheduling with required attendees (e.g., automated negotiated meeting scheduling with required attendees). In another example, one or more algorithms may provide for negotiated meeting scheduling with required attendees (e.g., automated negotiated meeting scheduling with required attendees).

In various embodiments, the negotiation in the scheduling of the meeting is carried out among the required attendees and it is only after the negotiation is complete (e.g., as indicated via confirmation by all the required attendees) that invitation(s) are sent to one or more optional attendees.

In the present disclosure the term “electronic calendar system” (also known sometimes as “agendas’) refers to a software program and/or associated hardware that has the capability of originating, accepting, arranging, organizing, tracking, scheduling and/or displaying one or more meetings (and/or proposed meetings) for a user thereof. In three specific examples (which are intended to be illustrative and not restrictive) an electronic calendar may be MICROSOFT OUTLOOK®, NOVEL GROUPWISE®, or LOTUS NOTES® from IBM™.

In the present disclosure the term “invitation” refers to a notification from an electronic calendar system inviting a recipient to participate in a meeting (e.g., in person, via telephone, via webcam, via web conference (e.g., SAMETIME™ meeting rooms from IBM™, MICROSOFT OFFICE COMMUNICATIONS SERVER™, (LYNC SERVER™), OPENMEETINGS™, TOKBOX™, WEBHUDDLE™, BIGBLUEBUTTON™) or via any other mechanism).

In the present disclosure the term “meeting attendee” refers to a recipient of an invitation to participate in a meeting (whether or not the person actually does participate in the meeting).

In the present disclosure the term “required meeting attendee” refers to an attendee who (at the time of invitation to a meeting) is considered (by a person sending the invitation) to be critical to the meeting.

In the present disclosure the term “optional meeting attendee” refers to an attendee who (at the time of invitation to a meeting) is not considered (by a person sending the invitation) to be critical to the meeting.

In the present disclosure the term “time” refers to one or more clock times (e.g., “1:30 PM” or “from 10:00 AM to 3:00 PM”), one or more days (e.g., “Monday” or “Thursday through Saturday”), one or more months (e.g., “January” or “March and April”), one or more dates (e.g., “Jan. 1, 2013” or “Feb. 1, 2013 to Feb. 10, 2013”) or any combination thereof.

Referring now to FIGS. 1A and 1B, an example implementation according to one embodiment is shown. More particularly, in this example: at Step 101—a meeting organizer begins to set up a meeting (using, e.g., an electronic calendar system) with at least one required meeting attendee and at least one optional meeting attendee; at Step 103—the meeting organizer (and/or the electronic calendar system) selects a best-guess proposal for an available time, based on calendar availability of each required meeting attendee (such a best-guess proposal may be made using any appropriate conventional technique or algorithm (such as discussed below)); at Step 105—invitations with the best-guess proposal for an available time are sent (e.g., by the electronic calendar system) only to each required meeting attendee; at Step 107—a response (which may be, for example, an acceptance notice or a decline notice) is received (e.g., by the electronic calendar system) from each required meeting attendee; at Step 109—a determination is made (e.g., by the electronic calendar system) if any decline notices are received—if so, a new best-guess proposal for an available time, based on calendar availability and/or feedback from each required meeting attendee is made (e.g., by the electronic calendar system) and the process returns to Step 105 for another iteration; at Step 111—after each required meeting attendee agrees on a time, invitation(s) with the agreed time are sent (e.g., by the electronic calendar system) to the optional meeting attendee(s).

Of note, at Step 101 the meeting organizer inputs all meeting attendees (that is, required meeting attendee(s) and optional meeting attendee(s)) into the system—however, the invitation(s) are not sent by the system to the optional meeting attendee(s) until all required meeting attendee(s) have agreed on a meeting time; it is only after this agreement is reached that the system sends the invitation(s) to the optional meeting attendee(s). This process allows the optional meeting attendee(s) to not receive multiple reschedule notices when their participation is optional.

To give a specific concrete example, the implementation described above may operate as follows: Mary (the meeting organizer) is attempting to set up a meeting with three required meeting attendees (Ron, Ray, and Rick) and three optional meeting attendees (Owen, Olivia, and Oden). The system sends an invitation to the three required meeting attendees (Ron, Ray, and Rick). Ron, Ray, and Rick carry out an iterative negotiation and finally all find a time slot that is agreed to after four reschedule attempts. Only at this point does an invitation go out to the three optional meeting attendees (Owen, Olivia, and Oden).

Of further note, with regard to Step 103 above, one example of an appropriate conventional algorithm may be such as used by LOTUS NOTES®, wherein it displays a list of times where all of the invitees are not already busy with other meetings (this often results in “no suggested options” if the invitees have many meetings). In another example, an algorithm may be used where the system finds a time where the majority of invitees are not already busy with other meetings. In yet other examples, there are systems, as with LOTUS NOTES®, where all invitees' availability are shown by color (e.g., busy, free, unavailable scheduling time) and the person scheduling chooses any time they want based on whatever criteria they want.

Referring now to FIGS. 2A and 2B, a computer-implemented method for scheduling a meeting with at least one required meeting attendee and at least one optional meeting attendee is shown. As seen in these FIGS. 2A and 2B, the method of this embodiment comprises: Step 201—receiving, by a processor, an identification of a first set of meeting attendees, wherein the first set of meeting attendees comprises at least one required meeting attendee; Step 203—receiving, by the processor, an identification of a second set of meeting attendees, wherein the second set of meeting attendees comprises at least one optional meeting attendee; Step 205—sending by the processor, after receipt of the identification of the first and second sets of meeting attendees, a required meeting attendee invitation to each required meeting attendee but not to any optional meeting attendee, wherein each required meeting attendee invitation comprises a proposed time for the meeting; Step 207—receiving, by the processor, from each required meeting attendee a response to the respective required meeting attendee invitation; Step 209—determining by the processor, based upon the response received from each respective required meeting attendee, whether each required meeting attendee has accepted the respective required meeting attendee invitation; and Step 211—sending by the processor, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In one example, the steps may be carried out in the order recited or the steps may be carried out in another order.

Referring now to FIG. 3, in another embodiment, a system 300 is provided. This system is for scheduling a meeting with at least one required meeting attendee and at least one optional meeting attendee. This system may include the following elements: an input element 301 configured to receive: (a) an identification of a first set of meeting attendees, wherein the first set of meeting attendees comprises at least one required meeting attendee, and (b) an identification of a second set of meeting attendees, wherein the second set of meeting attendees comprises at least one optional meeting attendee; a required meeting attendee invitation sending element 303 configured to send, after receipt of the identification of the first and second sets of meeting attendees, a required meeting attendee invitation to each required meeting attendee but not to any optional meeting attendee, wherein each required meeting attendee invitation comprises a proposed time for the meeting; a receiving element 305 configured to receive from each required meeting attendee a response to the respective required meeting attendee invitation; a determining element 307 configured to determine, based upon the response received from each respective required meeting attendee, whether each required meeting attendee has accepted the respective required meeting attendee invitation; and an optional meeting attendee invitation sending element 309 configured to send, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In one example: the determining element is further configured to determine, based upon the response received from each respective required meeting attendee, whether at least one required meeting attendee has declined the respective required meeting attendee invitation; and the required meeting attendee invitation sending element is further configured to send, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting (in one example, this modified proposed time for the meeting will be different from the original proposed time).

In another example: the receiving element is further configured to receive from each required meeting attendee a response to the respective modified required meeting attendee invitation; the determining element is further configured to determine, based upon the response received to the modified required meeting attendee invitation from each respective required meeting attendee, whether each required meeting attendee has accepted the respective modified required meeting attendee invitation; and

the optional meeting attendee invitation sending element is further configured to send, in response to the determination that each required meeting attendee has accepted the respective modified required meeting attendee invitation, an optional meeting attendee invitation to each optional meeting attendee, wherein the optional meeting attendee invitation comprises the modified proposed time agreed to by each required meeting attendee.

Each of the elements of FIG. 3 may be operatively connected together via system bus 302. In one example, communication between and among the various elements may be bi-directional. In another example, the communication (between/among the various elements and/or between/among an element and an outside component) may be carried out via the Internet, an intranet, a local area network, a wide area network and/or any other desired communication channel(s). In another example, some or all of these elements may be implemented in a computer system of the type shown in FIG. 5.

Referring now to FIG. 4, this figure depicts a block diagram of a system according to another embodiment. As seen in this FIG. 4, Meeting Organizer 401 may send invitations and receive responses via Network 403 (e.g., bi-directionally and electronically via an electronic calendar system) with any (or all) of: Required Meeting Attendee A (shown with call-out number 405A), Required Meeting Attendee B (shown with call-out number 405B), Required Meeting Attendee C (shown with call-out number 405C), Optional Meeting Attendee A (shown with call-out number 407A), and Optional Meeting Attendee B (shown with call-out number 407B).

Of course, while three Required Meeting Attendees and two Optional Meeting Attendees are shown in this FIG. 4, Meeting Organizer 401 may communicate with any appropriate desired number of Meeting Attendees.

Further, while FIG. 4 shows the various entities communicating, it is to be understood that this FIG. 4 is actually referring to communication by computer system(s) or the like that are owned, leased, operated, used by, in the possession of, and/or controlled by each of the entities.

In other examples, Network 403 may comprise the Internet and/or one or more Intranets, Local Area Networks, Wide Area Networks, or the like.

In addition, in other examples, various entities (e.g., Meeting Organizer and/or Meeting Attendees(s)) may be associated with the same organization or one or more different organizations.

Referring now to FIG. 5, this figure shows a hardware configuration of computing system 500 according to an embodiment of the present invention. As seen, this hardware configuration has at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communications adapter 534 for connecting the system 500 to a data processing network, the Internet, an Intranet, a local area network (LAN), etc., and a display adapter 536 for connecting the bus 512 to a display device 538 and/or printer 539 (e.g., a digital printer or the like).

In one embodiment, a computer-implemented method for scheduling a meeting with at least one required meeting attendee and at least one optional meeting attendee is provided, the method comprising: receiving, by a processor, an identification of a first set of meeting attendees, wherein the first set of meeting attendees comprises at least one required meeting attendee; receiving, by the processor, an identification of a second set of meeting attendees, wherein the second set of meeting attendees comprises at least one optional meeting attendee; sending by the processor, after receipt of the identification of the first and second sets of meeting attendees, a required meeting attendee invitation to each required meeting attendee but not to any optional meeting attendee, wherein each required meeting attendee invitation comprises a proposed time for the meeting; receiving, by the processor, from each required meeting attendee a response to the respective required meeting attendee invitation; determining by the processor, based upon the response received from each respective required meeting attendee, whether each required meeting attendee has accepted the respective required meeting attendee invitation; and sending by the processor, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In one example, the first set of meeting attendees comprises two or more required meeting attendees.

In another example, the second set of meeting attendees comprises a plurality of optional meeting attendees.

In another example, the identification of the first set of meeting attendees and the identification of the second set of meeting attendees is based upon input from a meeting organizer.

In another example, the identification of each attendee in the first set of meeting attendees and the second set of meeting attendees comprises an identification of contact information indicative of where to send each respective meeting invitation.

In another example, the method further comprises: determining by the processor, based upon the response received from each respective required meeting attendee, whether at least one required meeting attendee has declined the respective required meeting attendee invitation; and sending by the processor, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting.

In another example, the method further comprises: receiving, by the processor, from each required meeting attendee a response to the respective modified required meeting attendee invitation; determining by the processor, based upon the response received to the modified required meeting attendee invitation from each respective required meeting attendee, whether each required meeting attendee has accepted the respective modified required meeting attendee invitation; and sending by the processor, in response to the determination that each required meeting attendee has accepted the respective modified required meeting attendee invitation, an optional meeting attendee invitation to each optional meeting attendee, wherein each optional meeting attendee invitation comprises the modified proposed time agreed to by each required meeting attendee.

In another embodiment, a computer readable storage medium, tangibly embodying a program of instructions executable by the computer for scheduling a meeting with at least one required meeting attendee and at least one optional meeting attendee is provided, the program of instructions, in executing, performing the following steps: receiving an identification of a first set of meeting attendees, wherein the first set of meeting attendees comprises at least one required meeting attendee; receiving an identification of a second set of meeting attendees, wherein the second set of meeting attendees comprises at least one optional meeting attendee; sending, after receipt of the identification of the first and second sets of meeting attendees, a required meeting attendee invitation to each required meeting attendee but not to any optional meeting attendee, wherein each required meeting attendee invitation comprises a proposed time for the meeting; receiving from each required meeting attendee a response to the respective required meeting attendee invitation; determining, based upon the response received from each respective required meeting attendee, whether each required meeting attendee has accepted the respective required meeting attendee invitation; and sending, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In one example, the first set of meeting attendees comprises two or more required meeting attendees.

In another example, the second set of meeting attendees comprises a plurality of optional meeting attendees.

In another example, the identification of the first set of meeting attendees and the identification of the second set of meeting attendees is based upon input from a meeting organizer.

In another example, the identification of each attendee in the first set of meeting attendees and the second set of meeting attendees comprises an identification of contact information indicative of where to send each respective meeting invitation.

In another example, the program of instructions, in executing, further performs: determining, based upon the response received from each respective required meeting attendee, whether at least one required meeting attendee has declined the respective required meeting attendee invitation; and sending, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting.

In another example, the program of instructions, in executing, further performs: receiving from each required meeting attendee a response to the respective modified required meeting attendee invitation; determining, based upon the response received to the modified required meeting attendee invitation from each respective required meeting attendee, whether each required meeting attendee has accepted the respective modified required meeting attendee invitation; and sending, in response to the determination that each required meeting attendee has accepted the respective modified required meeting attendee invitation, an optional meeting attendee invitation to each optional meeting attendee, wherein each optional meeting attendee invitation comprises the modified proposed time agreed to by each required meeting attendee.

In another embodiment, a computer-implemented system for scheduling a meeting with at least one required meeting attendee and at least one optional meeting attendee is provided, the system comprising: an input element configured to receive: (a) an identification of a first set of meeting attendees, wherein the first set of meeting attendees comprises at least one required meeting attendee, and (b) an identification of a second set of meeting attendees, wherein the second set of meeting attendees comprises at least one optional meeting attendee; a required meeting attendee invitation sending element configured to send, after receipt of the identification of the first and second sets of meeting attendees, a required meeting attendee invitation to each required meeting attendee but not to any optional meeting attendee, wherein each required meeting attendee invitation comprises a proposed time for the meeting; a receiving element configured to receive from each required meeting attendee a response to the respective required meeting attendee invitation; a determining element configured to determine, based upon the response received from each respective required meeting attendee, whether each required meeting attendee has accepted the respective required meeting attendee invitation; and an optional meeting attendee invitation sending element configured to send, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

In one example, the first set of meeting attendees comprises two or more required meeting attendees.

In another example, the second set of meeting attendees comprises a plurality of optional meeting attendees.

In another example, the identification of the first set of meeting attendees and the identification of the second set of meeting attendees is based upon input from a meeting organizer via the input element.

In another example, the identification of each attendee in the first set of meeting attendees and the second set of meeting attendees comprises an identification of contact information indicative of where to send each respective meeting invitation.

In another example: the determining element is further configured to determine, based upon the response received from each respective required meeting attendee, whether at least one required meeting attendee has declined the respective required meeting attendee invitation; and the required meeting attendee invitation sending element is further configured to send, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting.

In another example: the receiving element is further configured to receive from each required meeting attendee a response to the respective modified required meeting attendee invitation; the determining element is further configured to determine, based upon the response received to the modified required meeting attendee invitation from each respective required meeting attendee, whether each required meeting attendee has accepted the respective modified required meeting attendee invitation; and the optional meeting attendee invitation sending element is further configured to send, in response to the determination that each required meeting attendee has accepted the respective modified required meeting attendee invitation, an optional meeting attendee invitation to each optional meeting attendee, wherein each optional meeting attendee invitation comprises the modified proposed time agreed to by each required meeting attendee.

As described herein are mechanisms for scheduling a meeting with required meeting attendees before optional meeting attendees receive invitation(s), comprising: identifying a set of required meeting attendees and a set of optional meeting attendees; scheduling a meeting with the set of required meeting attendees; and responsive to receiving agreement to the scheduled meeting by the set of required meeting attendees, sending a meeting invitation for the scheduled meeting to the set of optional meeting attendees.

In one example, the scheduling of the required meeting attendees is an iterative process allowing proposed times and counter proposals. In one specific example of such counter proposals, LOTUS NOTES® uses an algorithm where an invitee can indicate that the proposed time is not going to work for them and they can manually suggest a different proposed time that works for them (e.g., Monday from 5-6 pm). An extension of this would be that the invitee could provide a list of other good options for them. The system could then: (a) receive back any and all counter proposals; (b) determine if any of such counter proposals work for the group based on known availability; and (c) determine another suggested time.

In another example, the scheduling of the required meeting attendees is automated. In one specific example of such automated scheduling the invitee's calendaring system could determine that a time wouldn't work, and respond back with a different proposed time that is shown to be free on that invitee's calendar (e.g., Monday from 5-6 pm). The system could also provide a list of other times that all are shown to be free on that invitee's calendar. The scheduler's system could then: (a) receive back any and all counter proposals: (b) determine if any of such counter proposals work for the group based on known availability; and (c) determine another suggested time.

As described herein, in various embodiments an agreement is reached for a meeting time with the set of required meeting attendees before sending the meeting invitation(s) to the optional meeting attendee(s).

As described herein, various embodiments may provide in-line, normal processing of invitations between/among critical meeting attendees (e.g., critical peer meeting attendees) to occur while also permitting delaying the sending of invitation(s) to non-critical meeting attendees (e.g., non-critical peer meeting attendees) until the final negotiation between/among critical meeting attendees results in an agreed time.

As described herein, various embodiments may be implemented in the context of application servers, such as TOMCAT™ from APACHE™, JETTY™ from ECLIPSE FOUNDATION™, JONAS™ from OBJECT WEB™, JBOSS AS™ from JBOSS™ (division of RED HAT™), GERONIMO™ from APACHE™, TOMEE™ from APACHE™, RESIN JAVA APPLICATION SERVER™ from CAUCHO TECHNOLOGY™, BLAZIX™ from DESIDERATA SOFTWARE™, ENHYDRA SERVER™ from Enhydra.org, GLASSFISH™ from ORACLE™, WEBLOGIC APPLICATION SERVER™ from ORACLE™ and WEBSPHERE APPLICATION SERVER™ from IBM™.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A computer-implemented method for scheduling a meeting with at least one required meeting attendee and at least one optional meeting attendee, the method comprising:
receiving, by a processor, an identification of a first set of meeting attendees, wherein the first set of meeting attendees comprises at least one required meeting attendee;
receiving, by the processor, an identification of a second set of meeting attendees, wherein the second set of meeting attendees comprises at least one optional meeting attendee;
sending by the processor, after receipt of the identification of the first and second sets of meeting attendees, a required meeting attendee invitation to each required meeting attendee but not to any optional meeting attendee, wherein each required meeting attendee invitation comprises a proposed time for the meeting;
receiving, by the processor, from each required meeting attendee a response to the respective required meeting attendee invitation;
determining by the processor, based upon the response received from each respective required meeting attendee, whether each required meeting attendee has accepted the respective required meeting attendee invitation; and
sending by the processor, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

2. The method of claim 1, wherein the first set of meeting attendees comprises two or more required meeting attendees.

3. The method of claim 1, wherein the second set of meeting attendees comprises a plurality of optional meeting attendees.

4. The method of claim 1, wherein the identification of the first set of meeting attendees and the identification of the second set of meeting attendees is based upon input from a meeting organizer.

5. The method of claim 1, wherein the identification of each attendee in the first set of meeting attendees and the second set of meeting attendees comprises an identification of contact information indicative of where to send each respective meeting invitation.

6. The method of claim 1, further comprising:
determining by the processor, based upon the response received from each respective required meeting attendee, whether at least one required meeting attendee has declined the respective required meeting attendee invitation; and
sending by the processor, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting.

7. The method of claim 6, further comprising:
receiving, by the processor, from each required meeting attendee a response to the respective modified required meeting attendee invitation;
determining by the processor, based upon the response received to the modified required meeting attendee invitation from each respective required meeting attendee, whether each required meeting attendee has accepted the respective modified required meeting attendee invitation; and
sending by the processor, in response to the determination that each required meeting attendee has accepted the respective modified required meeting attendee invitation, an optional meeting attendee invitation to each optional meeting attendee, wherein each optional meeting attendee invitation comprises the modified proposed time agreed to by each required meeting attendee.

8. A computer readable storage medium, tangibly embodying a program of instructions executable by the computer for scheduling a meeting with at least one required meeting attendee and at least one optional meeting attendee, the program of instructions, in executing, performing the following steps:
receiving an identification of a first set of meeting attendees, wherein the first set of meeting attendees comprises at least one required meeting attendee;
receiving an identification of a second set of meeting attendees, wherein the second set of meeting attendees comprises at least one optional meeting attendee;
sending, after receipt of the identification of the first and second sets of meeting attendees, a required meeting attendee invitation to each required meeting attendee but not to any optional meeting attendee, wherein each required meeting attendee invitation comprises a proposed time for the meeting;
receiving from each required meeting attendee a response to the respective required meeting attendee invitation;
determining, based upon the response received from each respective required meeting attendeed, whether each required meeting attendee has accepted the respective required meeting attendee invitation; and
sending, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

9. The computer readable storage medium of claim 8, wherein the first set of meeting attendees comprises two or more required meeting attendees.

10. The computer readable storage medium of claim 8, wherein the second set of meeting attendees comprises a plurality of optional meeting attendees.

11. The computer readable storage medium of claim 8, wherein the identification of the first set of meeting attendees and the identification of the second set of meeting attendees is based upon input from a meeting organizer.

12. The computer readable storage medium of claim 8, wherein the identification of each attendee in the first set of meeting attendees and the second set of meeting attendees comprises an identification of contact information indicative of where to send each respective meeting invitation.

13. The computer readable storage medium of claim 8, wherein the program of instructions, in executing further performs:
determining, based upon the response received from each respective required meeting attendee, whether at least one required meeting attendee has declined the respective required meeting attendee invitation; and
sending, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting.

14. The computer readable storage medium of claim 13, wherein the program of instructions, in executing further performs:
receiving from each required meeting attendee a response to the respective modified required meeting attendee invitation;
determining, based upon the response received to the modified required meeting attendee invitation from each respective required meeting attendee, whether each required meeting attendee has accepted the respective modified required meeting attendee invitation; and
sending, in response to the determination that each required meeting attendee has accepted the respective modified required meeting attendee invitation, an optional meeting attendee invitation to each optional meeting attendee, wherein each optional meeting attendee invitation comprises the modified proposed time agreed to by each required meeting attendee.

15. A computer-implemented system for scheduling a meeting with at least one required meeting attendee and at least one optional meeting attendee, the system comprising:
an input element configured to receive: (a) an identification of a first set of meeting attendees, wherein the first set of meeting attendees comprises at least one required meeting attendee, and (b) an identification of a second set of meeting attendees, wherein the second set of meeting attendees comprises at least one optional meeting attendee;
a required meeting attendee invitation sending element configured to send, after receipt of the identification of the first and second sets of meeting attendees, a required meeting attendee invitation to each required meeting attendee but not to any optional meeting attendee, wherein each required meeting attendee invitation comprises a proposed time for the meeting;
a receiving element configured to receive from each required meeting attendee a response to the respective required meeting attendee invitation;
a determining element configured to determine, based upon the response received from each respective required meeting attendee, whether each required meeting attendee has accepted the respective required meeting attendee invitation; and
an optional meeting attendee invitation sending element configured to send, in response to the determination that each required meeting attendee has accepted the respective required meeting attendee invitation, an optional meeting attendee invitation to each optional meeting attendee, wherein each optional meeting attendee invitation comprises the proposed time agreed to by each required meeting attendee.

16. The system of claim 15, wherein the first set of meeting attendees comprises two or more required meeting attendees.

17. The system of claim 15, wherein the identification of the first set of meeting attendees and the identification of the second set of meeting attendees is based upon input from a meeting organizer via the input element.

18. The system of claim 15, wherein the identification of each attendee in the first set of meeting attendees and the second set of meeting attendees comprises an identification of contact information indicative of where to send each respective meeting invitation.

19. The system of claim 15, wherein:
the determining element is further configured to determine, based upon the response received from each respective required meeting attendee, whether at least one required meeting attendee has declined the respective required meeting attendee invitation; and
the required meeting attendee invitation sending element is further configured to send, in response to the determination that at least one required meeting attendee has declined the respective required meeting attendee invitation, a modified required meeting attendee invitation to each required meeting attendee but not to any optional meeting attendee, wherein each modified required meeting attendee invitation comprises a modified proposed time for the meeting.

20. The system of claim 19, wherein:
the receiving element is further configured to receive from each required meeting attendee a response to the respective modified required meeting attendee invitation;
the determining element is further configured to determine, based upon the response received to the modified required meeting attendee invitation from each respective required meeting attendee, whether each required meeting attendee has accepted the respective modified required meeting attendee invitation; and
the optional meeting attendee invitation sending element is further configured to send, in response to the determination that each required meeting attendee has accepted the respective modified required meeting attendee invitation, an optional meeting attendee invitation to each optional meeting attendee, wherein each optional meeting attendee invitation comprises the modified proposed time agreed to by each required meeting attendee.
